(19) United States
(12) Patent Application Publication
(10) Pub. No.: US 2026/0319183 A1
(43) Pub. Date: Oct. 15, 2026

(54) OPTICAL FIBER ADAPTER

(71) Applicant: YANGTZE OPTICAL FIBRE AND CABLE JOINT STOCK LIMITED COMPANY, Wuhan (CN)

(72) Inventors: Penglin GONG, WUHAN (CN); Xiupan FAN, WUHAN (CN); Hongchao LIU, WUHAN (CN); Juan YIN, WUHAN (CN); Wei ZHOU, WUHAN (CN); Qing ZHOU, WUHAN (CN); Ruijie HAN, WUHAN (CN); Siyuan ZHANG, WUHAN (CN)

(21) Appl. No.: 19/571,854

(22) Filed: Mar. 19, 2026

(30) Foreign Application Priority Data
Mar. 31, 2025 (CN) 202520589494.5

(51) Int. Cl. G02B 6/38

(52) U.S. Cl. CPC G02B 6/3825

(57) ABSTRACT

The invention relates to an optical fiber adapter comprising a housing, an inner core, and a sliding drive mechanism. The housing comprises a large-size end and a small-size end, the large-size end is configured to be detachably connected to a second connector, and a first channel is provided in the housing; the inner core is slidably abutted in the first channel of the housing and has a second channel therein, the second channel is a signal connection channel between the second connector and a first connector, and the inner core is configured to be detachably connected to the first connector; and one or more sliding drive mechanisms drive the inner core so that it has a tendency to slide away from the small-size end.

### CROSS-REFERENCE TO RELATED APPLICATION

This application claims priority to and benefit of China Patent Application No. 202520589494.5, filed Mar. 31, 2025, which is hereby incorporated herein in its entirety by reference.

### FIELD OF THE INVENTION

The present disclosure relates to the technical field of adapters, and in particular, to an optical fiber adapter.

### BACKGROUND OF THE INVENTION

There are numerous compatible Optitap connectors and adapters from various manufacturers on the market. Such an adapter in the prior art has an outer diameter of 30 mm, and a distance from a ferrule end face to a nut tightening abutment surface varies significantly among connectors of different manufacturers. The following problems exist:
1. Since the outer diameter of the adapter is approximately 30 mm, the distance between mounting holes is large, and thus the cost of a single adapter is high; meanwhile, since a single adapter has a large size and many adapters are mounted in a matching enclosure, a size of the matching enclosure would increase substantially, and the cost would also increase considerably;
2. There is significant variation in the distance from a ferrule end face to a nut tightening abutment surface among compatible Optitap connectors of different manufacturers. When these connectors are mated with connectors meeting IEC standards at the other end, this variation results in insufficient contact pressure between the two ferrules or a failure to achieve effective contact, and in turn leads to increased optical signal attenuation or optical link failure.

### SUMMARY OF THE INVENTION

In view of the shortcomings of the prior art, the objective of the present disclosure is to provide an optical fiber adapter, which can have a small mounting size and is self-adaptive to different distances from a ferrule end face to a nut tightening abutment surface, so as to ensure self-adaptive adjustments of two ferrules of an compatible Optitap connector and a connector meeting IEC standards of different manufacturers in the adapter and always ensure an effective optical link connection.

In order to solve the above technical problem, the technical solution of the present disclosure is:
an optical fiber adapter, including:
a housing, which includes a large-size end and a small-size end opposite the large-size end, wherein the large-size end is configured to be detachably connected to a second connector, and a first channel is provided inside the housing;
an inner core, which is slidably abutted in the first channel of the housing and has a second channel therein, wherein the second channel is a signal connection channel between the second connector and a first connector, and the inner core is configured to be detachably connected to the first connector; and
one or more sliding drive mechanisms, which drive the inner core so that it has a tendency to slide away from the small-size end.

Further, the housing includes at least one of the following features:
a first internal thread, which is disposed inside the large-size end, and is configured to be in threaded connection with a second external thread of a housing of the second connector; and
a first external thread, which is disposed outside the small-size end, wherein the optical fiber adapter is fixed to an enclosure via the first external thread.

Further, the sliding drive mechanism is in a first form or a second form, wherein
when the sliding drive mechanism is in the first form, the sliding drive mechanism includes an elastic element, a first abutment portion is provided inside the housing, and the inner core has a second abutment portion; one end of the elastic element abuts against the first abutment portion of the housing, and the other end of the elastic element abuts against the second abutment portion of the inner core; and an extension and contraction direction of the elastic element is parallel to an axial direction of the first channel; and
when the sliding drive mechanism is in the second form, the sliding drive mechanism includes magnetic elements, and the magnetic elements include a first magnet and a second magnet, wherein the first magnet is disposed inside the housing, and the second magnet is disposed on the inner core; a first magnetic pole of the first magnet and a second magnetic pole of the second magnet are disposed oppositely, and the first magnetic pole and the second magnetic pole have the same polarity; and the first magnetic pole and the second magnetic pole repel each other in a direction parallel to the axial direction of the first channel.

Further, a limiting structure is provided in the first channel of the housing to limit a sliding stroke of the inner core, and
the limiting structure includes an initial limiting portion located at an initial position of the sliding stroke and an extreme limiting portion located at an extreme position of the sliding stroke.

Further, the second abutment portion of the inner core abuts against the initial limiting portion when at the initial position, and abuts against the extreme limiting portion when at the extreme position.

Further, the initial limiting portion is provided in the first channel of the housing, and an disengagement preventing portion is disposed on the inner core; the initial limiting portion is configured to limit the initial position of the disengagement preventing portion sliding in the first channel, and the initial position is a position where the initial limiting portion and the disengagement preventing portion abut against each other; and
the extreme limiting portion is provided in the first channel of the housing, and the extreme limiting portion is configured to limit the extreme position of the second abutment portion of the inner core as the second abutment portion compresses the elastic element under the action of an external force and further slides in the first channel, and the extreme position is a position where the extreme limiting portion and the second abutment portion abut against each other.

Further, a first sliding groove is provided in the first channel, and the initial limiting portion is disposed in the first sliding groove; and a path of the first sliding groove extends at least from the initial limiting portion to the small-size end, and the disengagement preventing portion is slidably connected to the first sliding groove.

Further, either or both of the first abutment portion of the housing and the second abutment portion of the inner core has/have an accommodation space, and the elastic element is partially and/or fully accommodated in the accommodation space; and/or
either or both of the first abutment portion of the housing and the second abutment portion of the inner core is/are provided with a guide post, and the guide post runs partially and/or fully through the elastic element.

Further, a first chamfer is disposed at a port of the accommodation space away from the abutment portion of the housing, and the first chamfer is configured to assist in guiding an insertion of the elastic element.

Further, the port of the first chamfer extends circumferentially along the first channel to form the extreme limiting portion.

Further, a second sliding groove is provided in the first channel or on the inner core, and the extreme limiting portion is located at one end of a path of the second sliding groove; the path of the second sliding groove extends from the extreme limiting portion to the large-size end, and the second abutment portion of the inner core is slidably connected to the second sliding groove.

Further, a second chamfer is formed at one end of the second sliding groove away from the extreme limiting portion, and the second chamfer is configured to assist in guiding an insertion of the inner core.

Compared with the existing technologies, the present disclosure has the following advantages and beneficial effects:
1. The design of a floating inner core can self-adapt to compatible Optitap connectors which have different distances from a ferrule end face to a nut tightening abutment surface, so as to ensure self-adaptive adjustments of ferrules of an compatible Optitap connector and ferrules of a connector meeting IEC standards of different manufacturers during mating in the adapter and always ensuring effective connection of the link.
2. The adapter can be detachably connected to the enclosure via a small-size end, which avoids the need for an accommodation space for a large-size second connector compared with a detachable connection between a middle portion of a large-size housing of an adapter and an enclosure, so that the size of the adapter is reduced, thereby reducing the cost of adaptation and the cost of a matching enclosure.

### BRIEF DESCRIPTION OF THE DRAWINGS

Accompanying drawings illustrated herein are provided for further understanding of the present disclosure, and constitute a part of the present application. Exemplary embodiments of the present disclosure and the description thereof are provided for explaining the present disclosure, and do not constitute any inappropriate limitation to the present disclosure. In the accompanying drawings.

FIG. 1 is a schematic diagram of an overall structure of the present disclosure.

FIG. 2 is a schematic diagram of an exploded view of the overall structure of the present disclosure.

FIG. 3 is a full sectional view of the present disclosure.

FIG. 4 is a schematic diagram of a structure of a housing of the present disclosure.

FIG. 5 is a schematic diagram of a structure of a housing, viewed from another perspective, of the present disclosure.

FIG. 6 is a schematic diagram of a structure of an inner core of the present disclosure.

FIG. 7 is a schematic diagram of a structure of an inner core, viewed from another perspective, of the present disclosure.

FIG. 8 is a sectional view of the present disclosure when the inner core is mounted in the housing.

FIG. 9 is a sectional view of the present disclosure when an optical fiber adapter is connected to a first connector.

FIG. 10 is a sectional view of the present disclosure when the optical fiber adapter is connected to the first connector and a second connector.

### LIST OF REFERENCE NUMERALS

100, optical fiber adapter; 1, nut; 2, sealing gasket; 3, housing; 31, small, size end; 32, large, size end; 33, first channel; 34, first internal thread; 35, first port; 36, second port; 37, first external thread; 38, accommodation space; 39, first abutment portion; 310, first chamfer; 311, second sliding groove; 312, second chamfer; 313, first sliding groove; 314, extreme limiting portion; 315, initial limiting portion; 31501, second inclined surface; 4, sliding drive mechanism; 41, elastic element; 5, inner core; 51, second abutment portion; 52, disengagement preventing portion; 5201, first inclined surface; 53, second channel; 54, claw; 6, sleeve; 7, connecting cord; 71, connection ring; 8, dust cap; 9, sealing ring; 10, first connector; 101, first spring; 102, first ferrule; 103, first connector housing; 11, second connector; 111, second spring; 112, second ferrule; 113, second connector housing.

### DETAILED DESCRIPTION OF THE EMBODIMENTS

Technical solutions in embodiments of the present disclosure will be described clearly and completely in conjunction with accompanying drawings in the embodiments of the present disclosure below.

In the description of the present disclosure, it should be understood that, orientations or positional relationships indicated by terms “center”, “longitudinal”, “transverse”, “upper”, “lower”, “front”, “back”, “left”, “right”, “vertical”, “horizontal”, “top”, “bottom”, “inner”, “outer”, etc. are based on the orientations or position relationships shown in the drawings. These terms are only for the convenience of describing the present disclosure and simplifying the description and do not indicate or imply that the device or element referred to must have a specific orientation and be constructed and operated in a specific orientation, and therefore cannot be understood as limitation to the present disclosure. In addition, terms “first”, “second”, and “third” are only for the purpose of description and should not be interpreted as indicating or implying relative importance or implicitly indicate the number of the technical features referred. Thus, a feature defined by “first”, “second”, and the like may explicitly or implicitly include one or more of the feature referred. In the description of the present disclosure, unless otherwise indicated, “multiple” means two or more.

### Embodiment One

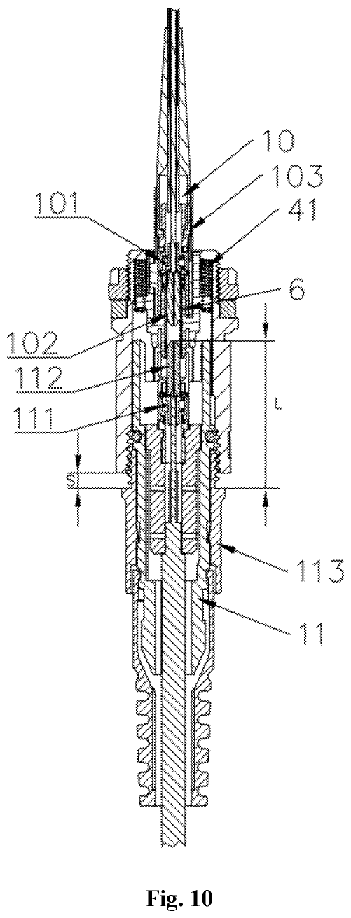

The present embodiment provides an optical fiber adapter 100, as shown in FIG. 10, which is configured to connect a first connector 10 and a second connector 11. The first connector 10 is a connector meeting IEC standards, and the second connector 11 is a compatible Optitap connector of different manufacturers. The first connector 10 has an overall size that is generally smaller than that of the second connector 11. The first connector 10 includes a first spring 101, a first ferrule 102, and a first connector housing 103. The first spring 101 drives the first ferrule 102 so that the first ferrule 102 has a tendency to extend, in an axial direction of the first ferrule 102, beyond the first connector housing 103. The second connector 11 includes a second spring 111, a second ferrule 112, and a second connector housing 113. The second spring 111 drives the second ferrule 112 so that the second ferrule 112 has a tendency to extend, in an axial direction of the second ferrule 112, beyond the second connector housing 113. The optical fiber adapter 100 provided in the present embodiment is specifically configured to realize an effective connection between the first ferrule 102 of the first connector 10 and the second ferrule 112 of the second connector 11.

In addition, the optical fiber adapter 100 provided in the present embodiment may also be mounted on an enclosure, and effective transmission of multiple optical paths can be realized by configuring multiple optical fiber adapters 100 on the enclosure.

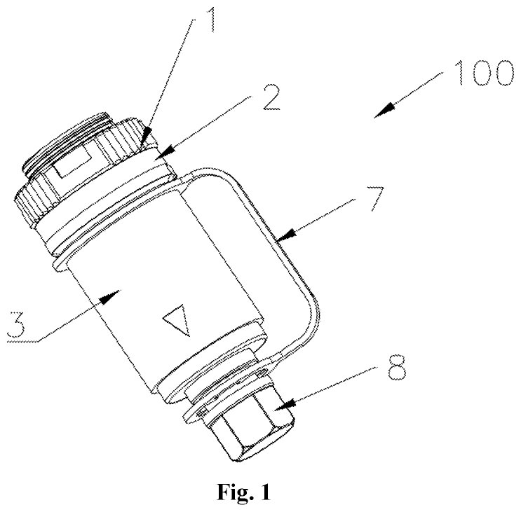

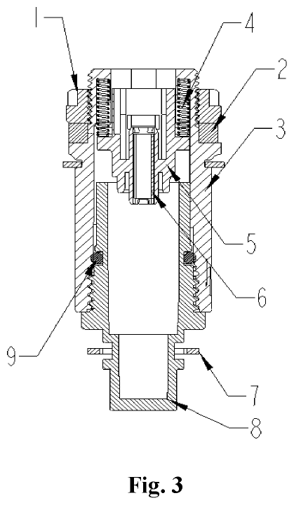

As shown in FIGS. 1-3, the optical fiber adapter 100 provided in the present embodiment includes a housing 3, an inner core 5, and one or more sliding drive mechanisms 4.

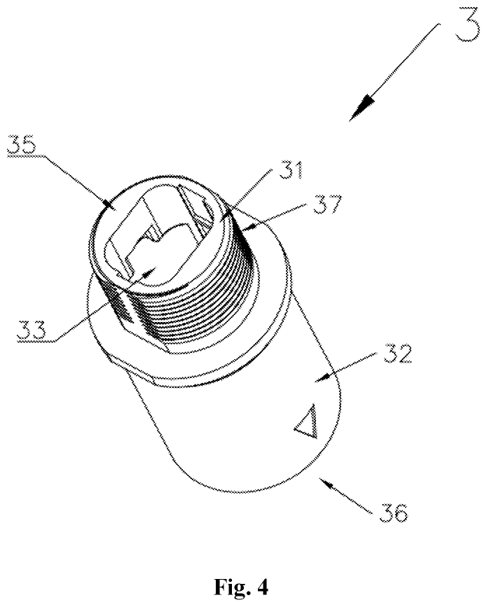

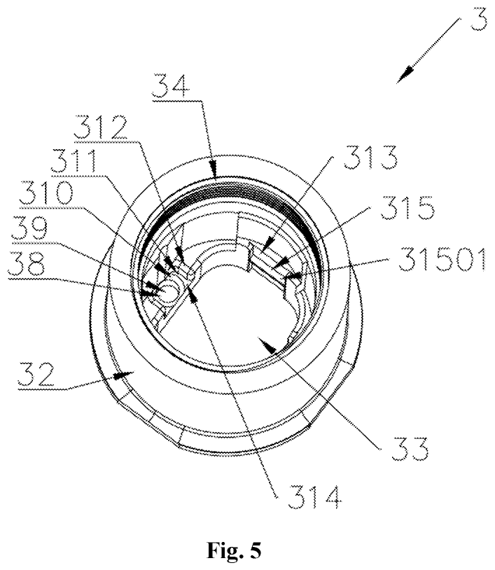

As shown in FIGS. 4 and 5, two ends of the housing 3 are different in size. That is, the housing 3 includes a large-size end 32 and a small-size end 31. The large-size end 32 is configured to be detachably connected to the second connector 11, and a first channel 33 is provided inside the housing 3. An end of the large-size end 32 communicating with the outside is a second port 36, which is configured for an insertion of the second connector 11; and an end of the small-size end 31 communicating with the outside is a first port 35, which is configured for an insertion of the first connector 10.

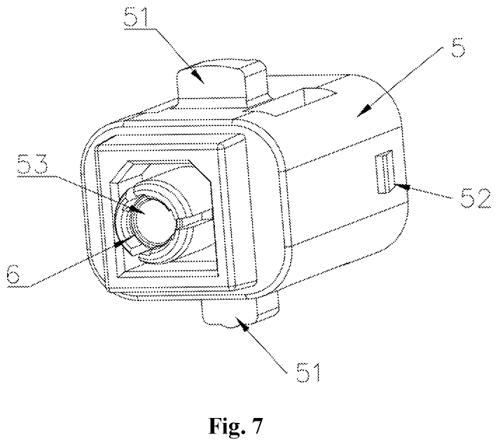

The inner core 5 is slidably abutted in the first channel 33 of the housing 3. As shown in FIG. 7, the inner core 5 has a second channel 53 therein, and the inner core 5 is configured to be detachably connected to the first connector 10. The second channel 53 is a signal connection channel between the second connector 11 and the first connector 10. Specifically, the second channel 53 is provided for an insertion of the first ferrule 102 of the first connector 10 and the second ferrule 112 of the second connector 11 so that the first ferrule 102 and the second ferrule 112 are connected effectively.

The sliding drive mechanism 4 drives the inner core 5 so that the inner core 5 has a tendency to slide away from the small-size end 31.

Two ends of the housing 3, of the optical fiber adapter 100 provided in the present embodiment, are different in size. Since the overall size of the first connector 10 is generally smaller than that of the second connector 11, the first connector 10 is inserted from the first port 35 of the small-size end 31, and the second connector 11 is inserted from the second port 36 of the large-size end 32. Compared with a large-size adapter for mounting a compatible Optitap connector, a size of the adapter provided in the present disclosure is greatly reduced, which saves cost. By using a housing 3 whose two ends are different in size, a radial size of the small-size end 31 is better matched with the size of the first connector 10. Besides, when the size of the optical fiber adapter 100 is reduced, the size of the matched enclosure is reduced correspondingly, which greatly lowers the cost.

According to the optical fiber adapter 100 provided in the present embodiment, by disposing the sliding drive mechanism 4 which drives the inner core 5 so that it has the tendency to slide away from the small-size end 31, when an external force acts on the second connector 11 located at the large-size end 32 and the second connector 11 enters into the optical fiber adapter 100 to connect with the first connector 10 located at the small-size end 31, the second connector 11 applies a pressure to the inner core 5. After the pressure is transmitted to the sliding drive mechanism 4, the sliding drive mechanism 4 applies a reaction force on the inner core 5. The pressure exerted on the inner core 5 by the second connector 11 and the reaction force exerted on the inner core 5 by the sliding drive mechanism 4 interact, to make the second ferrule 112 of the second connector 11 and the first ferrule 102 of the first connector 10 much closer in the second channel 53 of the inner core 5, so as to ensure an effective connection of the first ferrule 102 of the first connector 10 and the second ferrule 112 of the second connector 11 in the second channel 53.

In addition, with respect to the circumstance that a distance from a ferrule end face to a nut tightening abutment surface varies among compatible Optitap connectors of different manufacturers (the distance from the ferrule end face to the nut tightening abutment surface is shown by Lin FIG. 10), the smaller the distance, the smaller the pressure exerted on the inner core 5 by the second connector 11, and after the pressure is transmitted to the sliding drive mechanism 4, the smaller the reaction force exerted on the inner core 5 by the sliding drive mechanism 4, the smaller the floating length of the inner core 5; the larger the distance, the larger the pressure exerted on the inner core 5 by the second connector 11, and after the pressure is transmitted to the sliding drive mechanism 4, the larger the reaction force exerted on the inner core 5 by the sliding drive mechanism 4, the larger the floating length of the inner core 5. This ensures self-adaptive adjustments of two ferrules of a compatible Optitap connector and a connector meeting IEC standards in the adapter and always ensures an effective link connection.

In the present embodiment, the large-size end 32 and the second connector 11 may be in a threaded connection, a snap-fit connection, and the like, as long as the large-size end 32 and the second connector 11 are detachably connected, and the present embodiment does not make any limitation thereto.

In a specific implementation manner of the present embodiment, as shown in FIG. 5, the large-size end 32 has a first internal thread 34 inside the first channel 33, and the first internal thread 34 is configured to be in a threaded connection with a second external thread on the second connector 11. Specifically, the first internal thread 34 is configured to be in a threaded connection with the second external thread on a second connector housing 113. In order to ensure a stable contact between the first ferrule 102 and the second ferrule 112, an axial length of the first internal thread 34 on the housing 3 is greater than an axial length of the second external thread on the second connector housing 113.

In the present embodiment, an inner core 5 and the first connector 10 may be in a threaded connection, a snap-fit connection, and the like, as long as the inner core 5 and the first connector 10 are detachably connected, and the present embodiment does not make any limitation thereto.

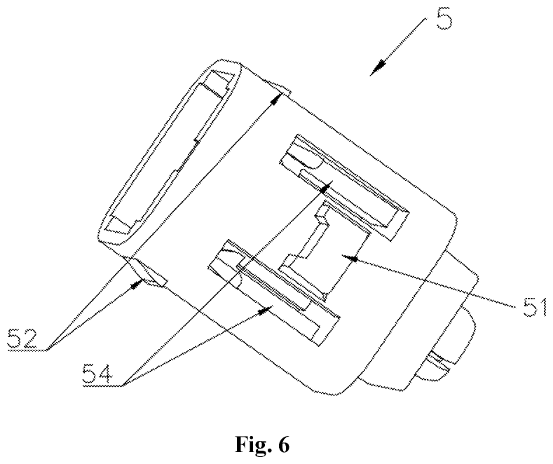

As shown in FIG. 6, two claws 54 are disposed symmetrically in the inner core 5, and are configured to fix the first connector 10. Specifically, the claws 54 have certain elasticity, and the claws 54 are mated, by snap-fitting, with a groove outside the first connector housing 103, so as to realize a connection between the inner core 5 and the first connector 10.

In the present embodiment, when it is needed to detachably connect the optical fiber adapter 100 to the enclosure, the small-size end 31 and the enclosure may be in a threaded connection, a snap-fit connection, and the like, as long as the small-size end 31 and the enclosure are detachably connected, and the present embodiment does not make any limitation thereto.

In a specific implementation manner of the present embodiment, as shown in FIG. 4, the small-size end 31 has a first external thread 37, and the first external thread 37 is configured to be fixed to a mounting hole in the enclosure by a nut 1 and a sealing gasket 2. The nut 1 and the sealing gasket 2 are sleeved on the housing 3 at an end of the first external thread 37, and are configured to fix and seal the small-size end 31.

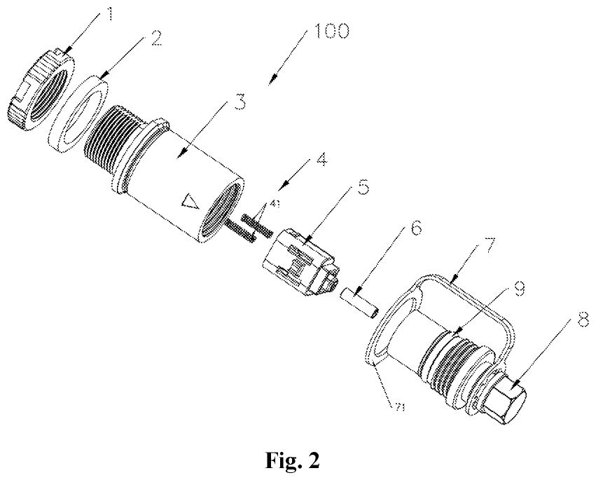

In the present embodiment, as shown in FIG. 2, the sliding drive mechanism 4 includes an elastic element 41. In the present embodiment, the elastic element 41 may be a spring, and in other feasible implementation manners, the elastic element 41 may also be a rubber block and the like. In the present embodiment, as shown in FIG. 5 to FIG. 8, a first abutment portion 39 is provided in the first channel 33, and the inner core 5 is provided with a second abutment portion 51. The first abutment portion 39 abuts against one end of the elastic element 41, and the second abutment portion 51 abuts against the other end of the elastic element 41. An extension and contraction direction of the elastic element 41 is parallel to an axial direction of the first channel 33. The elastic element 41 in the present disclosure drives the inner core 5 to tend to slide away from the small-size end 31.

In the present disclosure, a limiting structure is provided in the first channel 33 of the housing 3 to limit a sliding stroke of the inner core 5, and the limiting structure includes an initial limiting portion 315 located at an initial position of the sliding stroke and an extreme limiting portion 314 located at an extreme position of the sliding stroke. By limiting the initial position of the inner core 5 in the slide stroke using the initial limiting portion 315 and limiting the extreme position of the inner core 5 in the sliding stroke using the extreme limiting portion 314, the inner core 5 slides from the initial position to the extreme position under an indirect action of an external force exerted on the second connector 11. When a nut of the second connector 11 is fully tightened and a resultant force on the inner core 5 reaches a balance, the inner core 5 stops sliding, so as to adapt to a circumstance that a distance from a ferrule end face to a nut tightening abutment surface varies among compatible Optitap connectors of different manufacturers.

The initial limiting portion 315 is provided in the first channel 33 of the housing 3, and an disengagement preventing portion 52 is disposed on the inner core 5. The initial limiting portion 315 is configured to limit the initial position of the disengagement preventing portion 52 sliding in the first channel 33, and the initial position is a position where the initial limiting portion 315 and the disengagement preventing portion 52 abut against each other.

The extreme limiting portion 314 is provided in the first channel 33 of the housing 3, and the extreme limiting portion 314 is configured to limit the extreme position of the second abutment portion 51 of the inner core 5 as the second abutment portion compresses the elastic element 41 under the action of an external force and further slides in the first channel 33, and the extreme position is a position where the extreme limiting portion 314 and the second abutment portion 51 abut against each other.

As shown in FIG. 5, either or both of the first abutment portion 39 of the housing 3 and the second abutment portion 51 of the inner core 5 has/have an accommodation space 38, and the elastic element 41 is partially and/or fully accommodated in the accommodation space 38; and/or
either or both of the first abutment portion 39 of the housing 3 and the second abutment portion 51 of the inner core 5 is/are provided with a guide post, and the guide post runs partially and/or fully through the elastic element 41.

In the present embodiment, as shown in FIG. 5, the accommodation space 38 is a circular blind hole for accommodating the spring. The first abutment portion 39 is disposed in the accommodation space 38, and the first abutment portion 39 is specifically an inner bottom wall of the circular blind hole. The inner core 5 has the second abutment portion 51 which abuts against the other end of the elastic element 41, and an extension and contraction direction of the elastic element 41 is parallel to the axial direction of the first channel 33.

A first chamfer 310 is disposed at a port of the accommodation space 38 away from an abutment portion of the housing 3 abutting the elastic element 41. The first chamfer 310 is configured to assist in guiding an insertion of the elastic element 41.

As shown in FIG. 5, the port of the first chamfer 310 extends circumferentially along the first channel 33 to form the extreme limiting portion 314. The extreme limiting portion 314 is configured to limit the extreme position of the second abutment portion 51 sliding in the first channel 33, and the extreme position is a position where the extreme limiting portion 314 and the second abutment portion 51 abut against each other.

In a feasible implementation manner, the second abutment portion 51 is a grooved surface. When the extreme limiting portion 314 and the second abutment portion 51 abut against each other, the elastic element 41 is not fully compressed into the accommodation space 38 (the circular blind hole). That is, the accommodation space 38 is configured to accommodate a part of the elastic element 41. In another feasible implementation manner, the second abutment portion 51 is a flat surface. When the extreme limiting portion 314 and the second abutment portion 51 abut against each other, the elastic element 41 is fully compressed into the accommodation space 38 (the circular blind hole). That is, the accommodation space 38 is configured to accommodate the entire elastic element 41.

As shown in FIGS. 5, 6, and 8, the first channel 33 is provided at an inner wall with the initial limiting portion 315, and the inner core 5 is provided at an external wall with the disengagement preventing portion 52. The initial limiting portion 315 and the disengagement preventing portion 52 each present a wedge-shaped profile. The disengagement preventing portion 52 is provided thereon with a first inclined surface 5201, and the initial limiting portion 315 is provided thereon with a second inclined surface 31501 configured to match with the first inclined surface 5201. The initial limiting portion 315 and the disengagement preventing portion 52 each have certain elasticity. The initial limiting portion 315 is configured to limit the initial position of the disengagement preventing portion 52 sliding in the first channel 33, and the initial position is a position where the initial limiting portion 315 and the disengagement preventing portion 52 abut against each other.

Further, as shown in FIG. 5, a first sliding groove 313 is provided in the first channel 33, and the initial limiting portion 315 is disposed in the first sliding groove 313. A path of the first sliding groove 313 extends at least from the initial limiting portion 315 to the small-size end 31, and the disengagement preventing portion 52 is slidably connected to the first sliding groove 313. The number of the disengagement preventing portions 52 and the number of the first sliding grooves 313 are consistent and are one or more. When the number of the disengagement preventing portions 52 and the number of the first sliding grooves 313 are consistent and multiple, multiple disengagement preventing portions 52 are consistent or inconsistent in size, and multiple first sliding grooves 313 are consistent or inconsistent in size. Each first sliding groove 313 has a shape that is matched with a shape of one disengagement preventing portion 52.

In the present embodiment, as shown in FIGS. 5 and 6, the number of the disengagement preventing portions 52 and the number of the first sliding grooves 313 are respectively two. Two disengagement preventing portions 52 are disposed symmetrically on opposite sides of the inner core 5, and are not consistent in size. Each first sliding groove 313 has a shape that is matched with a shape of the corresponding disengagement preventing portion 52, which serves as a mistake proofing design to prevent reverse installation of the inner core 5.

In the present embodiment, the accommodation space 38 guides the extension and contraction of the elastic element 41. In another feasible implementation manner, a guide post may be disposed at one or both of the first abutment portion 39 and the second abutment portion 51, and the guide post runs partially or fully through the elastic element 41, so as to guide the extension and contraction of the elastic element 41.

In a feasible implementation manner, the guide post is fixedly disposed at the first abutment portion 39, and a length of the guide post is less than a depth of the accommodation space 38 (the circular blind hole). When the elastic element 41 is compressed to the extreme limiting portion 314, the guide post runs partially through the elastic element 41. In another feasible implementation manner, the guide post is fixedly disposed at the first abutment portion 39, and the length of the guide post is equal to the depth of the accommodation space 38 (the circular blind hole). When the elastic element 41 is compressed to the extreme limiting portion 314, the guide post runs fully through the elastic element 41. In the present embodiment, the accommodation space 38 may be disposed solely, or the guide post may be disposed solely.

In the present embodiment, the port of the first chamfer 310 extends circumferentially along the first channel 33 to form the extreme limiting portion 314. The extreme limiting portion 314 is configured to limit the extreme position of the second abutment portion 51 sliding in the first channel 33, and the extreme position is a position where the extreme limiting portion 314 and the second abutment portion 51 abut against each other.

Further, as shown in FIG. 5, the first channel 33 is provided with a second sliding groove 311, and the extreme limiting portion 314 is located at one end of a path of the second sliding groove 311. The path of the second sliding groove 311 extends from the extreme limiting portion 314 to the large-size end 32, and the second abutment portion 51 of the inner core 5 is slidably connected to the second sliding groove 311.

The number of the second abutment portions 51 and the number of the second sliding grooves 311 are consistent and are one or more. When the number of the second abutment portions 51 and the number of the second sliding grooves 311 are consistent and multiple, multiple second abutment portions 51 are consistent or inconsistent in size, and multiple second sliding grooves 311 are consistent or inconsistent in size. Each second sliding groove 311 has a shape that is matched with a shape of one second abutment portion 51.

In the present embodiment, as shown in FIGS. 5 and 7, the number of the second abutment portions 51 and the number of the second sliding grooves 311 are respectively two. Two second abutment portions 51 are disposed symmetrically on opposite sides of the inner core 5, and are not consistent in size. The second abutment portion 51 is boss-shaped. Each second sliding groove 311 has a shape that is matched with a shape of the corresponding second abutment portion 51, which serves as a mistake proofing design to prevent reverse installation of the inner core 5.

Further, as shown in FIG. 5, a second chamfer 312 is formed at one end of the second sliding groove 311 away from the extreme limiting portion 314, and the second chamfer 312 is configured to assist in guiding an insertion of the inner core 5.

In the present embodiment, as shown in FIGS. 2, 3, and 7, a sleeve 6 is fixedly disposed in the second channel 53 of the inner core 5 along an axial direction of the second channel 53, for an insertion of the first ferrule 102 of the first connector 10 and the second ferrule 112 of the second connector 11. The sleeve 6 is configured to improve the precision of mating of ferrules, and is generally a ceramic sleeve.

In a specific implementation manner of the present embodiment, an assembly process of the housing 3 and the inner core 5 is specifically as follows:

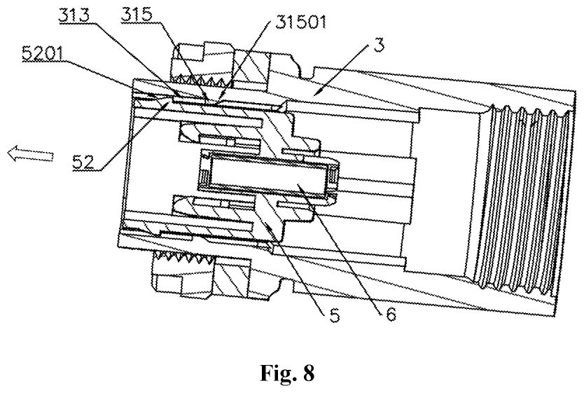

The inner core 5 is inserted through the second port 36 of the housing 3, and the second chamfer 312 assists in guiding an insertion of the inner core 5. During the process of the inner core 5 sliding into the housing 3, the first inclined surface 5201 and the second inclined surface 31501 are slidably mated. The arrow in FIG. 8 shows a sliding direction of the inner core 5 during installation. When the inner core 5 is mounted in position in the housing 3, the initial limiting portion 315 and the disengagement preventing portion 52 abut against each other, so as to prevent separation of the inner core 5 from the housing 3. At this time, the elastic element 41 is in a natural state or a slightly compressed state, and a length thereof is a mounting length.

A method of using the optical fiber adapter 100 provided in the specific implementation manner of the present embodiment to connect the first ferrule 102 of the first connector 10 and the second ferrule 112 of the second connector 11 is as follows.

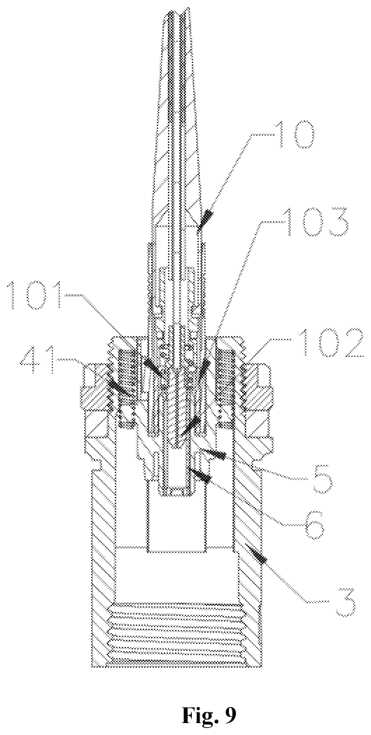

The optical fiber adapter 100 is connected to a housing of an installation box through the first external thread 37 of the housing 3, and the first connector 10 is inserted through the first port 35 of the housing 3. During this process, as shown in FIG. 9, the first spring 101 of the first connector 10 is compressed, and the first ferrule 102 overcomes a frictional force of the sleeve 6 when the first ferrule 102 is inserted into the sleeve 6, until the claw 54 in the inner core 5 is embedded in a groove outside the first connector 10, so as to realize locking of the first connector 10 with the optical fiber adapter 100.

Subsequently, the second connector 11 is inserted through the second port 36 of the housing 3, and the second spring 111 of the second connector 11 is compressed. The second ferrule 112 overcomes a frictional force of the sleeve 6 to move towards the small-size end 31, until the second ferrule 112 of the second connector 11 meets the first ferrule 102 of the first connector 10. At this time, there is still a distance S between the tightening abutment surface of the second external thread of the second connector 11 and an end surface of the optical fiber adapter 100, as shown in FIG. 10. Then, the second connector 11 is further tightened relative to the housing 3. The second connector 11 exerts a certain pressure on the inner core 5, and the pressure drives the inner core 5 to slide towards the small-size end 31, reducing the distance S to 0. At this time, the second ferrule 112 can contact with the first ferrule 102 stably, so that signals can be effectively transmitted through a link formed between the second ferrule 112 and the first ferrule 102. In addition, the introduction of the elastic element 41 allows the inner core 5 to be in a floating state, and a ferrule of a compatible Optitap connector, for which a distance from a ferrule end face to a nut tightening abutment surface varies, and a ferrule meeting IEC standards can perform self-adaptive adjustments in the adapter of the present embodiment to complete mating of two ferrules, so as to always ensure an effective link.

In the present embodiment, a compression length of the elastic element 41 is 1 mm to 4 mm, and a reaction force of the elastic element 41 is a reverse pre-tightening force of the elastic element 41, and a working elastic force of the elastic element 41 is 0.5 N to 10 N, so as to ensure that the first ferrule 102 and the second ferrule 112 still maintain stable contact in a free floating state, thereby avoiding signal jitter.

As shown in FIGS. 1 and 2, when the optical fiber adapter 100 is not connected to the second connector 11, in order to prevent contaminants such as dust from entering the optical fiber adapter 100, the optical fiber adapter 100 is further provided with a dust cap 8. Specifically, the dust cap 8 is provided at an outer circumference with an external thread mated with the first internal thread 34 inside the housing 3, and the external thread is configured to thread the dust cap 8 onto the housing 3. The dust cap 8 is connected with a connection ring 71 via a connecting cord 7, and the housing 3 is provided at an outer circumference with a circular groove configured to accommodate the connection ring 71. The connection ring 71 is sleeved in the circular groove for preventing the dust cap 8 from separation. A sealing ring 9 is sleeved on the dust cap 8 for further sealing an end of the housing 3.

### Embodiment Two

The present embodiment differs from embodiment one in that, the accommodation space 38 is disposed on the inner core 5 and is configured to accommodate a part of and/or the whole of the elastic element 41, and the accommodation space 38 is provided therein with a first abutment portion 39 which abuts against an end of the elastic element 41. Specifically, taking the elastic element 41 being a spring as an example, one or more first bosses are disposed on an outer wall of the inner core 5, and a circular blind hole for accommodating the spring is disposed at a side of the first boss facing the small-size end 31 of the housing 3. The circular blind hole is the accommodation space 38, and an inner bottom wall of the circular blind hole is the first abutment portion 39.

The housing 3 has a second abutment portion 51 which abuts against the other end of the elastic element 41. Specifically, one or more second bosses may be disposed on an inner wall of the housing 3, and a sliding groove provided for sliding of the first boss is disposed on the second boss and has an extension direction parallel to a sliding direction of the inner core 5; the sliding groove is open at one end and is closed at the other end thereof in a length direction, and the closed end is the second abutment portion 51. An extension and contraction direction of the elastic element 41 is parallel to an axial direction of the first channel 33.

A first chamfer 310 is disposed at a port of the accommodation space 38 away from the first abutment portion 39, and is configured to assist in guiding an insertion of the elastic element. An extreme limiting portion 314 is disposed on the housing 3, and the second abutment portion 51 is configured to limit the extreme position for sliding of the first boss in the first channel 33, and the extreme position is a position where the extreme limiting portion 314 and the second abutment portion 51 abut against each other.

### Embodiment Three

The present embodiment differs from embodiment one in that, the second abutment portion 51 and the disengagement preventing portion 52 on the inner core 5 are integrated into one solid component, and by means of this solid component, limiting two ends of a sliding path of the inner core 5 in the first channel 33 is realized. The second abutment portion 51 of the inner core 5 abuts against the initial limiting portion 315 when at the initial position, and abuts against the extreme limiting portion 314 when at the extreme position.

The inner core 5 is slidable between the initial position and the extreme position. When the inner core 5 moves towards the large-size end 32 and to an initial position of a sliding stroke, the second abutment portion 51 abuts against the initial limiting portion 315, so as to prevent the inner core 5 from separation; and when the inner core 5 moves away from the initial position, towards the small-size end 31, and to the extreme position of the sliding stroke, the second abutment portion 51 abuts against the extreme limiting portion 314, so as to limit movement of the inner core 5.

In this way, sliding of the inner core 5 between the initial position and the extreme position can be realized, so as to adapt to a circumstance that a distance from a ferrule end face to a nut tightening abutment surface varies among compatible Optitap connectors of different manufacturers. Moreover, compared with embodiment one, the second abutment portion 51 and the disengagement preventing portion 52 are integrated into one solid component in the present embodiment, with a smaller number of components.

Specifically, the above solid component is one or more third bosses disposed on the outer wall of the inner core 5. A side of the third boss facing the small-size end 31 of the housing 3 is a third abutment portion, and a side of the third boss away from the small-size end 31 of the housing 3 is a fourth abutment portion. A fourth boss is disposed on the inner wall of the housing 3, and a sliding groove provided for sliding of the third boss is disposed on the fourth boss. An extension direction of the sliding groove is parallel to a sliding direction of the inner core 5.

The sliding groove is closed at both ends in a length direction. The accommodation space 38 configured to accommodate a part of and/or the whole of the elastic element 41 is disposed at one closed end of the sliding groove close to the small-size end 31 of the housing 3, and the initial limiting portion 315 is disposed at the other closed end of the sliding groove. The initial limiting portion 315 is configured to limit the initial position of the third boss sliding in the sliding groove, and the initial position is a position where the fourth abutment portion and the initial limiting portion 315 abut against each other.

A fifth abutment portion configured to abut against one end of the elastic element 41 is disposed in the accommodation space 38, and the other end of the elastic element 41 abuts against the third abutment portion of the third boss. The extreme limiting portion 314 is disposed on a middle portion of the sliding groove and on a sliding path of the third boss. The extreme limiting portion 314 is configured to limit the extreme position of the third boss sliding in the sliding groove, and the extreme position is a position where the third abutment portion and the extreme limiting portion 314 abut against each other.

### Embodiment Four

The present embodiment differs from embodiment one in that, the sliding drive mechanism 4 includes magnetic elements, and the magnetic elements include a first magnet and a second magnet which are both permanent magnets. The first magnet is disposed inside the first channel 33 of the housing 3, and the second magnet is disposed on the inner core 5. A first magnetic pole of the first magnet and a second magnetic pole of the second magnet are disposed oppositely, and the first magnetic pole and the second magnetic pole have the same polarity. One or more first magnets may be disposed, and the number of the second magnets is the same as that of the first magnets; and the first magnet and the corresponding second magnet repel each other in a direction parallel to the axial direction of the first channel 33.

Unlike providing a tendency that the inner core 5 slides away from the small-size end 31 and providing a pre-tightening force after the first ferrule 102 and the second ferrule 112 are connected, by elasticity of the elastic element 41 in Embodiment 1, in the present embodiment, the tendency that the inner core 5 slides away from the small-size end 31 and the pre-tightening force after the first ferrule 102 and the second ferrule 112 are both provided by a repelling force between the first magnet and the second magnet.

The above embodiments are only exemplary illustration for the technical solution of the present disclosure. The method related in the present disclosure is not merely limited to contents described in the above embodiments, but shall be determined by the scope as defined in the claims. Any amendment or supplement or equivalent replacement made by those skilled in the art of the present disclosure based on the embodiments falls into the scope claimed by claims of the present disclosure.

What is claimed is:

1. An optical fiber adapter, comprising:
a housing, which comprises a large-size end and a small-size end opposite the large-size end, wherein the large-size end is configured to be detachably connected to a second connector, and a first channel is provided inside the housing;
an inner core, which is slidably abutted in the first channel of the housing and has a second channel therein, wherein the second channel is a signal connection channel between the second connector and a first connector, and the inner core is configured to be detachably connected to the first connector; and
one or more sliding drive mechanisms, which drive the inner core so that the inner core has a tendency to slide away from the small-size end.

2. The optical fiber adapter according to claim 1, wherein
the housing comprises at least one of the following features:
a first internal thread, which is disposed inside the large-size end, and is configured to be in threaded connection with a second external thread of a housing of the second connector; and
a first external thread, which is disposed outside the small-size end, wherein the optical fiber adapter is fixed to an enclosure via the first external thread.

3. The optical fiber adapter according to claim 1, wherein
the sliding drive mechanism is in a first form or a second form, wherein
when the sliding drive mechanism is in the first form, the sliding drive mechanism comprises an elastic element, a first abutment portion is provided in the housing, and the inner core has a second abutment portion; one end of the elastic element abuts against the first abutment portion of the housing, and the other end of the elastic element abuts against the second abutment portion of the inner core; and an extension and contraction direction of the elastic element is parallel to an axial direction of the first channel; and
when the sliding drive mechanism is in the second form, the sliding drive mechanism incorporates magnetic elements, and the magnetic elements comprise a first magnet and a second magnet, wherein the first magnet is disposed inside the housing, and the second magnet is disposed on the inner core; a first magnetic pole of the first magnet and a second magnetic pole of the second magnet are disposed oppositely, and the first magnetic pole and the second magnetic pole have the same polarity; and the first magnetic pole and the second magnetic pole repel each other in a direction parallel to the axial direction of the first channel.

4. The optical fiber adapter according to claim 3, wherein
a limiting structure is provided in the first channel of the housing to limit a sliding stroke of the inner core, and
the limiting structure comprises an initial limiting portion located at an initial position of the sliding stroke and an extreme limiting portion located at an extreme position of the sliding stroke.

5. The optical fiber adapter according to claim 4, wherein
the second abutment portion of the inner core abuts against the initial limiting portion when at the initial position, and abuts against the extreme limiting portion when at the extreme position.

6. The optical fiber adapter according to claim 4, wherein
the initial limiting portion is provided in the first channel of the housing, and an disengagement preventing portion is disposed on the inner core; the initial limiting portion is configured to limit the initial position of the disengagement preventing portion sliding in the first channel, and the initial position is a position where the initial limiting portion and the disengagement preventing portion abut against each other; and
the extreme limiting portion is provided in the first channel of the housing, and the extreme limiting portion is configured to limit the extreme position of the second abutment portion of the inner core as the second abutment portion compresses the elastic element under the action of an external force and further slides in the first channel, and the extreme position is a position where the extreme limiting portion and the second abutment portion abut against each other.

7. The optical fiber adapter according to claim 6, wherein
a first sliding groove is provided in the first channel, and the initial limiting portion is disposed in the first sliding groove; and a path of the first sliding groove extends at least from the initial limiting portion to the small-size end, and the disengagement preventing portion is slidably connected to the first sliding groove.

8. The optical fiber adapter according to claim 4, wherein
either or both of the first abutment portion of the housing and the second abutment portion of the inner core has/have an accommodation space, and the elastic element is partially and/or fully accommodated in the accommodation space; and/or
either or both of the first abutment portion of the housing and the second abutment portion of the inner core is/are provided with a guide post, and the guide post runs partially and/or fully through the elastic element.

9. The optical fiber adapter according to claim 8, wherein
a first chamfer is disposed at a port of the accommodation space away from the abutment portion of the housing, and the first chamfer is configured to assist in guiding an insertion of the elastic element.

10. The optical fiber adapter according to claim 9, wherein
the port of the first chamfer extends circumferentially along the first channel to form the extreme limiting portion.

11. The optical fiber adapter according to claim 6, wherein
a second sliding groove is provided in the first channel or on the inner core, and the extreme limiting portion is located at one end of a path of the second sliding groove; the path of the second sliding groove extends from the extreme limiting portion to the large-size end, and the second abutment portion of the inner core is slidably connected to the second sliding groove.

12. The optical fiber adapter according to claim 11, wherein
a second chamfer is formed at one end of the second sliding groove away from the extreme limiting portion, and the second chamfer is configured to assist in guiding an insertion of the inner core.
